(19) United States
(12) Patent Application Publication
(10) Pub. No.: US 2026/0140806 A1
(43) Pub. Date: May 21, 2026

(54) INFORMATION PROCESSING METHOD, INFORMATION PROCESSING SYSTEM, AND COMPUTER PROGRAM

(71) Applicant: GS Yuasa International Ltd., Kyoto-shi (JP)

(72) Inventor: Nan UKUMORI, Kyoto-shi (JP)

(21) Appl. No.: 19/451,733

(22) Filed: Jan. 16, 2026

Related U.S. Application Data
(63) Continuation of application No. PCT/JP2024/025867, filed on Jul. 19, 2024.

(30) Foreign Application Priority Data
Jul. 20, 2023 (JP) 2023-118558

(51) Int. Cl. G06F 11/07

(52) U.S. Cl. CPC G06F 11/0751; G06F 11/073

(57) ABSTRACT

An information processing method includes performing, using a computer, processing including acquiring time-series measurement data of a plurality of energy storage devices, and generating compressed data by performing compression processing on difference data between acquired time-series measurement data of each of the plurality of energy storage devices and reference measurement data.

### CROSS REFERENCE TO RELATED APPLICATIONS

This application claims the benefit of priority to Japanese Patent Application No. 2023-118558 filed on Jul. 20, 2023 and is a Continuation Application of PCT Application No. PCT/JP2024/025867 filed on Jul. 19, 2024. The entire contents of each application are hereby incorporated herein by reference.

### BACKGROUND OF THE INVENTION

### 1. Field of the Invention

The present invention relates to information processing methods, information processing systems, and non-transitory computer-readable media including computer programs.

### 2. Description of the Related Art

Energy storage devices are widely used in uninterruptible power systems, DC power supplies, etc. Large-scale systems that store renewable energy or power generated by existing power generating systems increasingly use energy storage devices. A large-scale system uses a plurality of energy storage devices.

For stable operation of a system using energy storage devices, it is important to grasp the state and life of each energy storage device. For methods of state diagnosis, life prediction, etc., of energy storage devices, various methods such as a method of using measurement data of voltages, currents, temperatures, etc. observed at the time of charging or discharging of energy storage devices have been proposed and improved in accuracy (see, for example, JP-A-2013-003115).

### SUMMARY OF THE INVENTION

A large-scale energy storage system is constructed using a large number of energy storage devices. For example, in a large-scale photovoltaic system called mega solar, a very large number of energy storage devices, for example, several million energy storage devices are installed. That number is much larger than the number of energy storage devices used, for example, for the power or auxiliary equipment of a vehicle or the like. If data is measured at predetermined intervals at each energy storage device in such a large-scale energy storage system, the amount of measurement data obtained is enormous. It is not easy to compile and accurately grasp the enormous amount of measurement data. The execution of various types of processing on the entire enormous amount of measurement data requires a considerable amount of processing time. A technique suitable for processing using a plurality of pieces of measurement data is desired.

Example embodiments of the present disclosure provide techniques suitable for processing using a plurality of pieces of measurement data.

An information processing method according to an example embodiment of the present disclosure includes performing, using a computer, processing including acquiring time-series measurement data of a plurality of energy storage devices, and generating compressed data by performing compression processing on difference data between acquired time-series measurement data of each of the plurality of energy storage devices and reference measurement data.

Example embodiments of the present disclosure provide techniques suitable for processing using a plurality of pieces of measurement data.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a diagram illustrating an outline of a remote monitoring system of the present example embodiment of the present invention.

FIG. 2 is a block diagram illustrating a configuration example of a power generating system.

FIG. 3 is a block diagram illustrating a configuration example of an information processing device.

FIG. 4 is a block diagram illustrating a configuration example of a terminal device.

FIG. 5 is a functional block diagram illustrating a configuration example of the information processing device.

FIG. 6 is a diagram illustrating an example of compressed data.

FIG. 7 is a schematic diagram illustrating an example of a screen displayed on a display unit of the terminal device.

FIG. 8 is a flowchart illustrating an example of processing steps performed by the information processing device.

### DETAILED DESCRIPTION OF THE EXAMPLE EMBODIMENTS

(1) An information processing method according to an example embodiment of the present disclosure includes performing, using a computer, processing including acquiring time-series measurement data of a plurality of energy storage devices, and generating compressed data by performing compression processing on difference data between acquired time-series measurement data of each of the plurality of energy storage devices and reference measurement data.

According to the information processing method described in (1), measurement data acquired from a plurality of energy storage devices included in a large-scale energy storage system can be converted into compressed data into which the measurement data is compressed. In the present specification, the compression processing preferably is lossy compression, not so-called lossless compression that allows compression and decompression. By reducing original data information by compressing the measurement data, the enormous amount of measurement data can be converted into a form that is easy to handle and provided as data suitable for subsequent processing. The generation of the compressed data allows a reduction in excess noise and an improvement in the accuracy of subsequent data analysis. By compressing the difference data between the measurement data and the reference measurement data instead of compressing the measurement data itself, a deviation from a reference state can be reflected in the compressed data, and the behavior of each energy storage device in a group can be appropriately grasped.
(2) The information processing method according to (1), includes detecting an anomaly in each of the plurality of energy storage devices based on the compressed data.

According to the information processing method described in (2), the use of the compressed data into which the measurement data is compressed allows an improvement in the descriptiveness of anomaly detection. By performing anomaly detection based on the measurement data as a relative value to the reference state, erroneous detection can be reduced to detect an anomaly with high accuracy. The use of the compressed data prevents an increase in processing load on the large-scale energy storage system, leading to efficient anomaly detection.
(3) The information processing method according to (1) or (2) includes outputting distribution information visualizing distribution of the compressed data.

According to the information processing method described in (3), the distribution state of the compressed data can be visualized and presented, and a user can visually and clearly recognize the distribution of the compressed data. The presentation of the compressed information allows the state of each energy storage device to be easily grasped at a glance.
(4) The information processing method according to any one of (1) to (3), includes classifying the compressed data into a normal cluster and an anomalous cluster using a clustering method, and detecting an anomaly in each of the plurality of energy storage devices based on a result of the classifying.
According to the information processing method described in (4), anomaly detection can be easily and accurately performed using the clustering method. By using the clustering method, which is a type of machine learning method, an anomaly can be detected from features based on the obtained measurement data, so that individual dependency in anomaly detection can be reduced. Using the compressed data allows a reduction in load and an improvement in the accuracy of clustering, as compared with using the measurement data itself. Using an unsupervised learning algorithm eliminates the need for the preparation of training data, and allows an unknown anomaly to be identified with high accuracy.
(5) The information processing method according to (4), includes superimposing the normal cluster and the anomalous cluster on distribution information visualizing distribution of the compressed data and outputting in a visually distinguishable form.

According to the information processing method described in (5), the distribution state of the compressed data and the anomaly detection result can be presented in association with each other, and the user can visually and clearly recognize those pieces of information. The presentation of the visualized anomaly detection result enhances the descriptiveness of anomaly detection.
(6) The information processing method according to any one of (1) to (5), includes generating a difference between a mean value or a median value of the acquired time-series measurement data of the plurality of energy storage devices at a same point in time as the reference measurement data and the acquired time-series measurement data of each of the plurality of energy storage devices.

According to the information processing method described in (6), the reference measurement data can be calculated based on the measurement data of the plurality of energy storage devices. Using a relative value to the reference measurement data that takes the actual states of the plurality of energy storage devices into consideration allows an improvement in the accuracy of processing such as anomaly detection performed thereafter. An energy storage device of a different nature exhibiting a behavior deviating from the group can be detected with high accuracy.
(7) In the information processing method according to any one of (1) to (6), the compression processing may be performed using principal component analysis, UMAP, t-SNE, or an autoencoder.

According to the information processing method described in (7), the dimensions of the measurement data can be easily and accurately reduced using a machine learning method. The data can be compressed while holding original features, so that the compressed data appropriately reflecting the behavior of each energy storage device can be generated. Using an unsupervised learning algorithm eliminates the need for the preparation of training data, and allows accurate recognition of the varying features of the measurement data.
(8) In the information processing method according to any one of (1) to (7), the acquired time-series measurement data may include at least one of a voltage, a temperature, or a state of charge (SOC) of each of the plurality of energy storage devices.

According to the information processing method described in (8), by using, among measurement data, data of the voltage, the temperature, the SOC, or a combination thereof that is highly sensitive to change and favorably reflects the internal state of each energy storage device, data properly representing the state of each energy storage device can be provided.
(9) The information processing method according to any one of (2) to (8), includes detecting an anomaly in each of the plurality of energy storage devices using an energy storage device simulator that estimates the acquired time-series measurement data of the energy storage device based on an internal state of the energy storage device.

According to the information processing method described in (9), anomaly detection using the energy storage device simulator can be performed in addition to anomaly detection using the above-described method, so that multifaceted determination is possible. Since measurement data of each energy storage device depends on an internal state quantity of the energy storage device, using a simulator that can take into account the internal state of each energy storage device in anomaly detection reduces erroneous detection. However, in general, it is difficult for the simulator to handle an internal state that is not assumed by an engineer. Thus, by using it in combination with a method of detecting an anomaly by anomaly detection processing using a machine learning method, focusing on features of measurement data itself subjected to detection, the reliability of anomaly detection for both assumed and unknown anomalies is further enhanced.
(10) An information processing system according to an example embodiment of the present disclosure includes an acquisition processor configured or programmed to acquire time-series measurement data of a plurality of energy storage devices, and a generation processor configured or programmed to generate compressed data by performing compression processing on difference data between acquired time-series measurement data of each of the plurality of energy storage devices and reference measurement data.
(11) A non-transitory computer-readable medium including a computer program according to an example embodiment of the present disclosure is executable to cause a computer to perform processing including acquiring time-series measurement data of a plurality of energy storage devices, and generating compressed data by performing compression processing on difference data between acquired time-series measurement data of each of the plurality of energy storage devices and reference measurement data.

Hereinafter, the present disclosure will be described in detail with reference to the drawings illustrating example embodiments thereof.

### First Example Embodiment

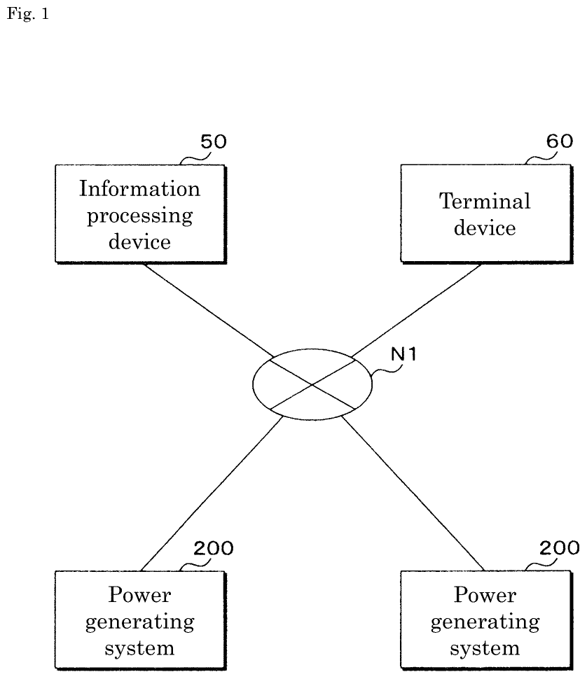

FIG. 1 illustrates an outline of a remote monitoring system 100 of the present example embodiment. Information on energy storage devices included in power generating systems 200 in the remote monitoring system 100 is remotely accessible. The remote monitoring system 100 is an example of an information processing system. The remote monitoring system 100 includes an information processing device 50 as a main device. The information processing device 50 collects information from the power generating systems 200 to be remotely monitored. The information processing device 50 is connected to a network N1 such as the Internet. A terminal device 60 and the power generating systems 200 are connected to the network N1.

The information processing device 50 and the terminal device 60 are not limited to separate devices. The information processing device 50 and the terminal device 60 may be, for example, the same processing device. The information processing device 50 and/or the terminal device 60 may be integrated into any of the power generating systems 200. The number of power generating systems 200 may be one or three or more.

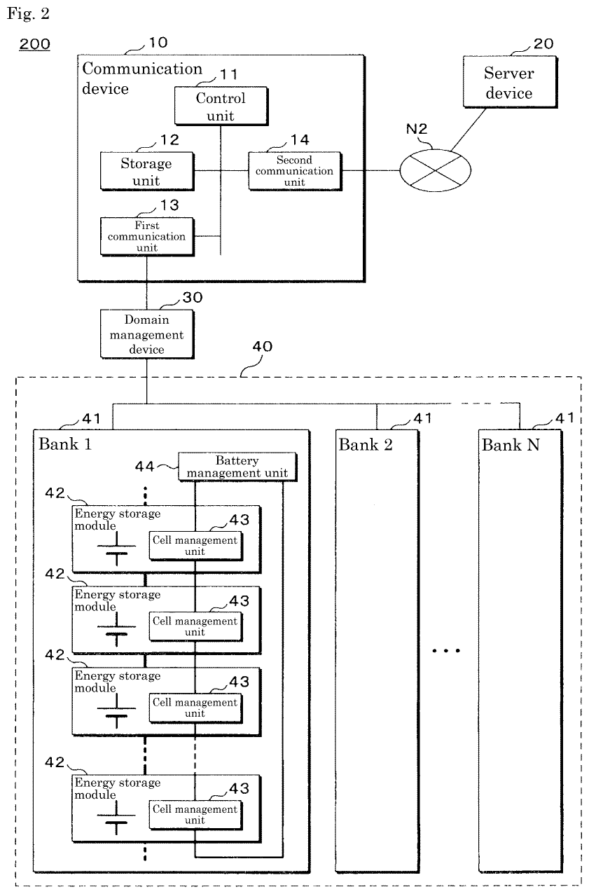

FIG. 2 is a block diagram illustrating a configuration example of one of the power generating systems 200. A power generating apparatus such as a photovoltaic system or a wind power system is not illustrated. The power generating system 200 includes a communication device 10, a domain management device 30, and an energy storage unit (domain) 40. A server device 20 is connected to the communication device 10 via a network N2. The energy storage unit 40 may include a plurality of banks 41. The energy storage unit 40 is, for example, housed in a battery cabinet and used for a thermal power system, a mega-solar power generating system, a wind power system, an uninterruptible power supply (UPS), a stabilized power supply system for a railway, or the like. A configuration including the communication device 10, the domain management device 30, and the energy storage unit 40 is referred to as an energy storage system. The energy storage system may include a power conditioner (not illustrated). The energy storage unit 40 is not limited to industrial applications, and may be for home use.

A business operator performs operations to design, introduce, manage, and maintain the energy storage system including the communication device 10, the domain management device 30, and the energy storage unit 40, and can remotely monitor the energy storage system with the remote monitoring system 100.

The communication device 10 includes a control unit 11, a storage unit 12, a first communication unit 13, and a second communication unit 14. The control unit 11 includes a central processing unit (CPU) etc., and controls the entire communication device 10 using built-in memory such as read-only memory (ROM) and random-access memory (RAM).

The storage unit 12 includes, for example, a non-volatile storage device such as flash memory. The storage unit 12 can store necessary information and can store, for example, information obtained by processing of the control unit 11.

The first communication unit 13 includes a communication interface that enables communication with the domain management device 30 or a battery management unit 44. The control unit 11 can communicate with the domain management device 30 through the first communication unit 13.

The second communication unit 14 includes a communication interface that enables communication via the network N2. The control unit 11 can communicate with the server device 20 through the second communication unit 14.

The domain management device 30 transmits and receives information to and from each bank 41, using a given communication interface. The storage unit 12 can store measurement data acquired via the domain management device 30.

The server device 20 can collect measurement data of the energy storage system from the communication device 10. The measurement data includes measurement values of the current, the voltage, the temperature, etc. of each energy storage device in the energy storage system. The server device 20 may sort and store the collected measurement data on an individual energy storage device basis. The server device 20 can transmit the measurement data to the information processing device 50 via the networks N2 and N1. Note that the networks N1 and N2 may be a single communication network.

Each bank 41 is formed by connecting a plurality of energy storage modules in series, and includes a battery management unit (BMU) 44, a plurality of energy storage modules 42, a cell management unit (CMU) 43 provided in each energy storage module 42, etc.

In each energy storage module 42, a plurality of energy storage cells are connected in series. The power generating system 200 is a large-scale energy storage system including a large number of energy storage cells, for example, one million or more energy storage cells. The energy storage cells are an example of the energy storage devices. The energy storage devices are preferably rechargeable ones such as secondary batteries such as lead-acid batteries or lithium ion batteries, or capacitors. Some of the energy storage devices may be non-rechargeable primary batteries. The term “energy storage device” may refer to each energy storage module 42, each bank 41, or the domain in which the banks 41 are connected in parallel.

Each cell management unit 43 acquires measurement data on each energy storage cell of the corresponding energy storage module 42. The measurement data can be acquired repeatedly in an appropriate cycle of, for example, 0.1 seconds, 0.5 seconds, one second, or the like.

The battery management unit 44 can communicate with the cell management units 43 with a communication function via serial communication, and can acquire measurement data detected by the cell management units 43. The battery management unit 44 can transmit and receive information to and from the domain management device 30. The domain management device 30 aggregates measurement data from the battery management units 44 of the banks belonging to the domain. The domain management device 30 outputs the aggregated measurement data to the communication device 10. Thus, the communication device 10 can acquire the measurement data of the energy storage unit 40 via the domain management device 30 and store the measurement data.

The communication device 10 transmits, at a predetermined timing (for example, at regular intervals or when the amount of data satisfies a predetermined condition), the measurement data stored since the previous timing to the server device 20. The communication device 10 transmits the measurement data associated with identification information (for example, cell IDs) of the energy storage cells. The communication device 10 may transmit all the measurement data obtained via the domain management device 30, or may transmit the measurement data reduced at a predetermined rate.

The information processing device 50 acquires the measurement data of the energy storage cells provided in the power generating system 200 via the server device 20, and monitors the state of the power generating system 200 based on the acquired measurement data. The information processing device 50 converts the acquired measurement data into a form easy to handle, using a machine learning method, and performs anomaly detection on the energy storage cells using the converted data. The information processing device 50 presents the results of various types of analysis processing to a user through the terminal device 60. In the present specification, machine learning means machine learning in a broad sense including multivariate analysis such as clustering and principal component analysis.

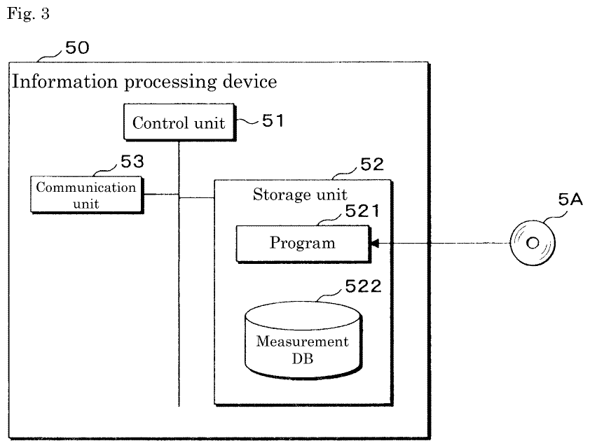

FIG. 3 is a block diagram illustrating a configuration example of the information processing device 50. The information processing device 50 is a computer capable of various types of information processing and information transmission and reception, and is, for example, a server computer, a personal computer, a quantum computer, or the like. The information processing device 50 may be a multicomputer consisting of a plurality of computers, or may be a virtual machine virtually constructed by software. The information processing device 50 includes a control unit 51, a storage unit 52, and a communication unit 53.

The control unit 51 is an arithmetic circuit including a CPU, a graphics processing unit (GPU), ROM, RAM, etc. The CPU or the GPU included in the control unit 51 executes various computer programs stored in the ROM and the storage unit 52, to control the operations of the hardware components described above. The control unit 51 may have functions such as a timer to measure the elapsed time from when a measurement start instruction is given to when a measurement end instruction is given, a counter to count numbers, and a clock to output date and time information.

The storage unit 52 includes a nonvolatile storage device such as flash memory or a hard disk drive. The storage unit 52 stores various computer programs, data, etc. to be referred to by the control unit 51. The storage unit 52 may be an external storage device connected to the information processing device 50.

The storage unit 52 of the present example embodiment stores a program 521 to cause the computer to execute processing using measurement data, and a measurement database (DB) 522 as data necessary for the execution of the program 521.

The measurement DB 522 is a database that stores measurement data received from each power generating system 200. As described above, the measurement data includes measured values of the currents, voltages, temperatures, etc. of the energy storage cells in the power generating system 200. The measurement data includes data at the time of charging or discharging of the energy storage cells. In addition to the measured values of the currents, the voltages, the temperatures, etc. provided by the cell management units 43, the measurement data may include calculation values calculated using those measured values (for example, the SOC). The measurement DB 522 stores, for example, a record in which the identification information of the energy storage cells and information such as a measurement date and time and measured values are associated, based on an ID for identifying measurement data. The measurement DB 522 may further store the result of anomaly detection etc. Each time measurement data transmitted from the server device 20 is received, the control unit 51 stores the received measurement data in the measurement DB 522 in chronological order.

The computer programs including the program 521 (program products) may be provided via a non-transitory recording medium 5A on which the computer programs are readably recorded. The recording medium 5A is a portable memory such as a CD-ROM, a USB memory, or a Secure Digital (SD) card. The control unit 51 reads a desired computer program from the recording medium 5A, using a reader (not illustrated), and stores the read computer program in the storage unit 52. Alternatively, the computer programs may be provided through communication. The program 521 may be a single computer program or may consist of a plurality of computer programs, and may be executed on a single computer or on a plurality of computers interconnected by a communication network.

The communication unit 53 includes a communication interface that enables communication via the network N1. The control unit 51 receives measurement data transmitted from each power generating system 200 via the communication unit 53. The control unit 51 transmits various processing results to an external device such as the terminal device 60 through the communication unit 53.

The information processing device 50 may include a display unit to display various types of information, an operation unit to receive a user's operation, etc.

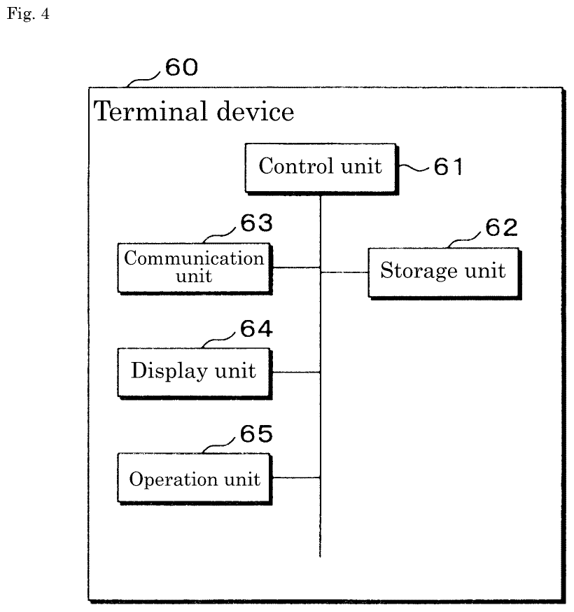

FIG. 4 is a block diagram illustrating a configuration example of the terminal device 60. The terminal device 60 is a computer capable of various types of information processing and information transmission and reception, and is, for example, a personal computer, a smartphone, a tablet terminal, or the like. The terminal device 60 is used by the user such as an administrator, a maintenance person, or an operator of the storage battery system of the power generating system 200. The terminal device 60 includes a control unit 61, a storage unit 62, a communication unit 63, a display unit 64, an operation unit 65, etc.

The control unit 61 is an arithmetic circuit including a CPU, ROM, RAM, etc. The CPU or a GPU included in the control unit 61 executes various computer programs stored in the ROM and the storage unit 62, to control the operations of the hardware components described above.

The storage unit 62 includes a nonvolatile storage device such as flash memory or a hard disk drive. The storage unit 62 stores various computer programs, data, etc. to be referred to by the control unit 61. The control unit 61 causes the display unit 64 to display various processing results provided by the information processing device 50, based on a computer program stored in the storage unit 62.

The communication unit 63 includes a communication interface that enables communication via the network N1. The control unit 61 transmits and receives information to and from the information processing device 50 through the communication unit 63.

The display unit 64 includes a display device such as a liquid crystal display or an organic electro-luminescent display (OELD). The display unit 64 displays information to be communicated to the user in accordance with an instruction from the control unit 61. The display unit 64 may be replaced with a notification unit that is a means to communicate the information to the user with another means such as voice.

The operation unit 65 is an interface that receives the user's operation. The operation unit 65 includes, for example, a keyboard, a touch panel device with a built-in display, a speaker, a microphone, etc. The operation unit 65 receives input of an operation from the user and transmits a control signal corresponding to the content of the operation to the control unit 61.

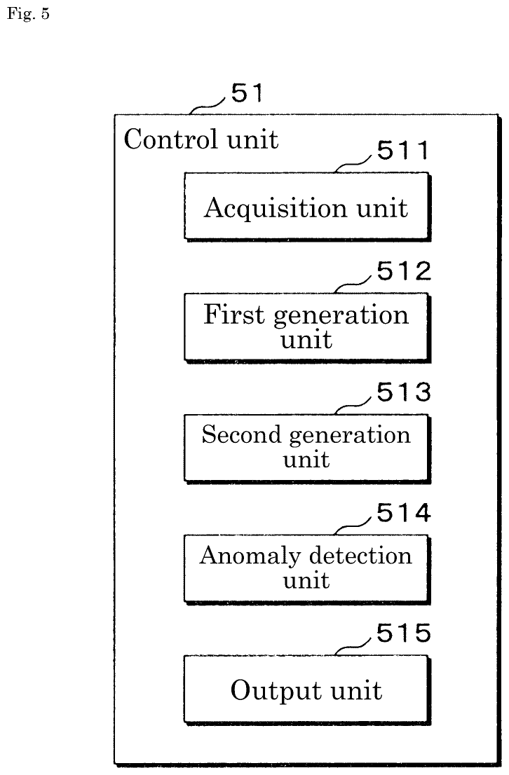

FIG. 5 is a functional block diagram illustrating a configuration example of the information processing device 50. The control unit 51 of the information processing device 50 reads and executes the program 521 stored in the storage unit 52, thereby implementing the functions of an acquisition unit 511, a first generation unit 512, a second generation unit 513, an anomaly detection unit 514, and an output unit 515. Each functional unit of the information processing device 50 may be implemented by software, or may be implemented by hardware, or may be implemented by a combination thereof.

The acquisition unit 511 acquires time-series measurement data in a predetermined period set in advance for a plurality of energy storage cells in each power generating system 200. The measurement data is associated with identification information of the energy storage cells. The acquisition unit 511 may acquire the measurement data transmitted from the server device 20 via the communication unit 53, or may acquire the measurement data by reading the measurement data stored in the measurement DB 522. The predetermined period may be, for example, one hour, one day, one month, or the like.

The measurement data includes one piece or a plurality of pieces of data selected from the voltage, the temperature, the SOC, the current, and the power of each energy storage cell. From the viewpoint of improving anomaly detection accuracy, the measurement data preferably includes at least one of the voltage, the temperature, and the SOC, and more preferably, includes the voltage. In the present example embodiment, voltage data of the energy storage cells is acquired as the measurement data.

The acquisition unit 511 may acquire the measurement data for all the energy storage cells in the power generating system 200. However, by selecting, of all the energy storage cells, a predetermined number of energy storage cells for which to acquire the measurement data, the processing load can be reduced. The energy storage cells for which to acquire the measurement data may be selected in advance according to a predetermined rule or manually. The energy storage cells for which to acquire the measurement data are preferably, for example, energy storage cells representing the load or the temperature in each unit of specific units (e.g., banks) into which the power generating system 200 is divided. The number of energy storage cells for which to acquire the measurement data can be determined with the total number of energy storage cells in the power generating system 200 taken into consideration.

Based on the voltage data of each energy storage cell acquired by the acquisition unit 511, the first generation unit 512 generates difference data representing the difference between the voltage value of the energy storage cell and a reference voltage value. The first generation unit 512 determines time-series difference data by calculating, at each measurement time, the difference between the voltage value of the energy storage cell and the reference voltage value at the same point in time (the same measurement time). As the reference voltage value, for example, the mean value or the median value of the voltage values of all the energy storage cells at the same measurement time is used. The difference data is high-dimensional data including the number of pieces of data corresponding to the number of times of measurement of the voltage values.

The second generation unit 513 compresses the difference data generated by the first generation unit 512, using a predetermined compression method, to generate compressed data. The compression method may be a dimensionality reduction method. For example, principal component analysis (PCA), Uniform Manifold Approximation and Projection (UMAP), t-distributed stochastic neighbor embedding (t-SNE), an autoencoder, or the like can be used. As the dimensionality reduction method, principal component analysis is preferable. The second generation unit 513 generates low-dimensional data in which the dimensions of the difference data are reduced by reduction processing. In the case where the compressed data is presented to the user using distribution information described below or the like, the compressed data is preferably data reduced to two dimensions or three dimensions.

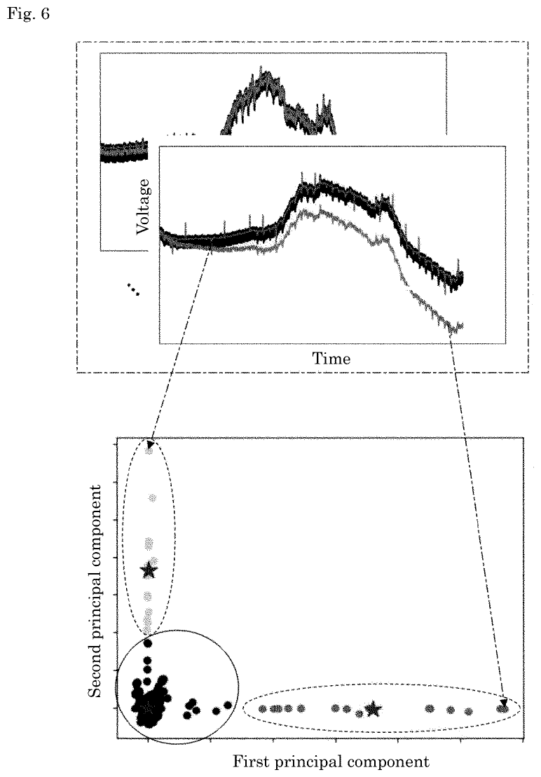

FIG. 6 is a diagram illustrating an example of the compressed data. FIG. 6 illustrates an example in which the measurement data of the energy storage cells in the predetermined period is two-dimensionally compressed using principal component analysis. In FIG. 6, the compressed data of the energy storage cells is mapped onto two-dimensional coordinates with the horizontal axis as the first principal component and the vertical axis as the second principal component. As conceptually illustrated in FIG. 6, the voltage data for the predetermined period corresponding to a certain energy storage cell is converted into compressed data indicated by a plot.

In the case of performing dimensionality reduction using principal component analysis, the second generation unit 513 may determine principal components to be used, based on the cumulative contribution rate of each component. The second generation unit 513 may extract a preset number of principal components in descending order of the cumulative contribution rate, to compress the difference data to a predetermined number of dimensions. The second generation unit 513 may extract principal components whose cumulative contribution rates are higher than or equal to a preset threshold value.

It is preferable that one piece of compressed data is generated based on difference data for the predetermined period that is a measurement data acquisition unit. However, in the case where the predetermined period is relatively long, the predetermined period may be divided into preset time units, and compressed data may be generated at each time unit. The compressed data generation unit may be set appropriately according to the purpose of analytical processing using the measurement data.

The second generation unit 513 may combine a plurality of compression methods to perform compression processing. For example, the second generation unit 513 may further reduce the dimensions with UMAP after performing principal component analysis.

The anomaly detection unit 514 detects an anomaly in each energy storage cell, based on the compressed data of the energy storage cell generated by the second generation unit 513. The anomaly detection unit 514 of the present example embodiment performs anomaly detection using k-means, which is a clustering method.

k-means is a type of unsupervised machine learning, and automatically classifies pieces of compressed data into clusters whose number is specified in advance. In the present example embodiment, as illustrated in FIG. 6, the number of clusters is set to three, so that pieces of compressed data are classified into a normal cluster and the remaining (two) anomalous clusters. In FIG. 6, a cluster enclosed by a solid line is the normal cluster, and clusters enclosed by broken lines are the anomalous clusters.

In k-means, the distance between compressed data and the center of each cluster (for example, the Euclidean distance, the Mahalanobis distance, or the like) is calculated, and the compressed data is classified into the cluster with the smallest calculated distance. The anomaly detection unit 514 can regard, of a plurality of clusters generated, the cluster to which the largest number of pieces of compressed data belong as a normal cluster, and regard the remaining clusters as anomalous clusters. The anomaly detection unit 514 identifies an anomalous energy storage cell, based on the result of clustering of the compressed data of the energy storage cells.

In the above description, anomaly detection is performed using k-means, but an anomaly detection method is not limited thereto as long as the presence or absence of an anomaly can be determined for the compressed data of each energy storage cell. The anomaly detection unit 514 may use a method such as hierarchical clustering, the k-nearest neighbors algorithm, an autoregressive model, a neural network, or a support vector machine. The anomaly detection unit 514 may use a plurality of anomaly detection methods in combination.

The output unit 515 outputs screen information indicating the compressed data generated by the second generation unit 513 and the anomaly detection result provided by the anomaly detection unit 514 to the terminal device 60. The control unit 61 of the terminal device 60 displays a screen showing the compressed data and the anomaly detection result on the display unit 64, based on the screen information transmitted through the output unit 515.

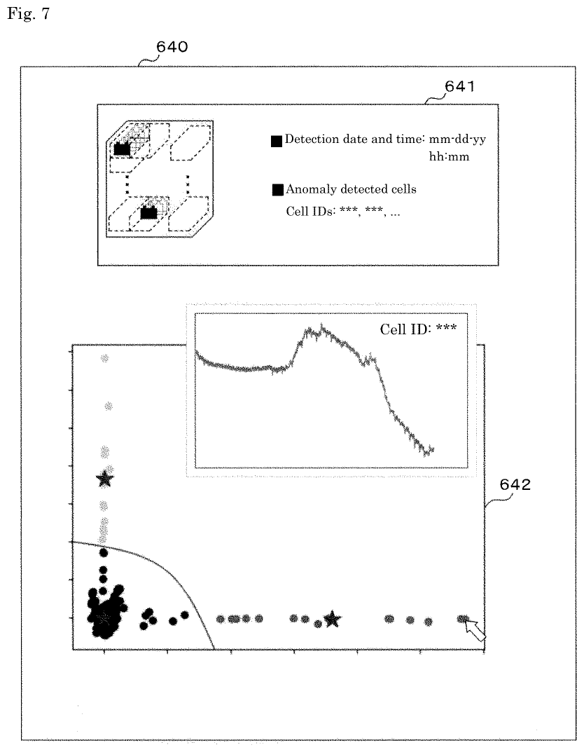

FIG. 7 is a schematic diagram illustrating an example of a screen 640 displayed on the display unit 64 of the terminal device 60. The screen 640 includes a result display section 641 to display information on energy storage cells detected as anomalous, and a data display section 642 to display the compressed data of each energy storage cell.

The output unit 515 receives the anomaly detection result provided by the anomaly detection unit 514, and causes the result display section 641 to display energy storage cells detected as anomalous in a visually identifiable form. In FIG. 7, the result display section 641 displays the cell IDs of the energy storage cells detected as anomalous and an illustration showing their disposed positions in the power generating system 200.

The output unit 515 receives the compressed data from the second generation unit 513 and generates distribution information visualizing the distribution of the received compressed data. The output unit 515 causes the data display section 642 to display the generated distribution information. The distribution information is, for example, a distribution chart in which the compressed data of each energy storage cell is mapped onto n-dimensional coordinates with the first axis (horizontal axis) as the first principal component, the second axis (vertical axis) as the second principal component, the n-th axis as the n-th principal component . . . FIG. 7 illustrates a two-dimensional distribution chart.

Information visually recognizably indicating the clustering result or the anomaly detection result provided by the anomaly detection unit 514 may be superimposed on the distribution chart. In FIG. 7, the compressed data is displayed on the distribution chart using markers with different colors or shades (different shades in FIG. 7) depending on the clusters, to visualize and present the clustering result. A solid line that separates the region of the normal cluster from the regions of the anomalous clusters is displayed on the distribution chart, so that the anomaly detection result is presented visually distinguishably.

The markers indicating the pieces of compressed data on the distribution chart may be configured to be selectable. For example, when the selection of any marker on the distribution chart is received through the terminal device 60, the output unit 515 reads the identification information, the measurement data before compression, etc. of the energy storage cell corresponding to the received marker, based on the information stored in the storage unit 52. As illustrated in FIG. 7, the output unit 515 causes the read identification information and measurement data to be displayed in a pop-up form or in another window.

The information processing device 50 may not include the anomaly detection unit 514, and may be configured to perform up to the generation of compressed data. In this case, only compressed data is output as the result of processing. Anomaly detection may be performed by the user based on the compressed data provided through the terminal device 60.

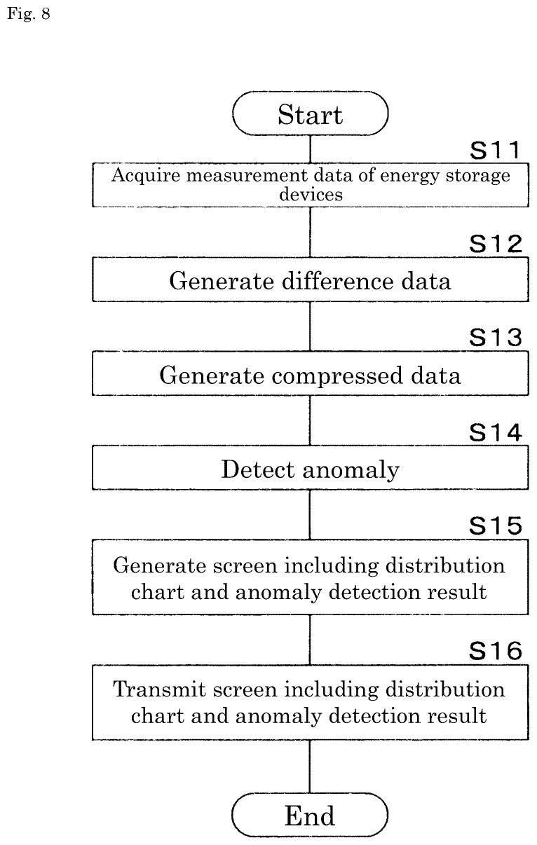

FIG. 8 is a flowchart illustrating an example of processing steps performed by the information processing device 50. Each piece of processing in the flowchart below is performed by the control unit 51 according to the program 521 stored in the storage unit 52 of the information processing device 50. The control unit 51 periodically performs the following processing steps.

The control unit 51 of the information processing device 50 acquires time-series measurement data in the predetermined period of each of the plurality of energy storage cells included in the power generating system 200 (step S11). The measurement data is, for example, voltage data.

The control unit 51 calculates the difference between the voltage value of each energy storage cell and the reference voltage value, based on the acquired voltage data of the energy storage cells, to generate difference data of each energy storage cell (step S12). The difference data is time-series data of the voltage difference. For example, the control unit 51 calculates the mean value or the median value of the voltage values of all the energy storage cells at the same measurement time to obtain the reference voltage value at each measurement time. The control unit 51 calculates the difference between the reference voltage value and the voltage value of a target energy storage cell for which the difference data is to be generated at each measurement time, to generate the difference data of the target energy storage cell. The difference data is generated for each of the plurality of energy storage cells.

The above has described the case where the mean value or the median value of the measurement data of all the energy storage cells is used as an example of a reference value (the reference voltage value in the present example). However, there is no need to limit the reference value thereto. A reference may be set in advance (a separate experimental value may be used), an updated reference value to which the reference value is appropriately learned and updated may be used, or a value to which the reference value is corrected using a defining equation, the mean value or the median value of measurement data from a plurality of energy storage cells randomly selected by a computer, or the mean value or the median value of a plurality of representative energy storage cells selected in advance may be used. Alternatively, an ideal reference value obtained by calculating the reference value with simulation may be used. These reference values may be selected according to the circumstances or situation.

The control unit 51 performs compression processing using principal component analysis on the generated difference data to generate compressed data of each energy storage cell (step S13). The control unit 51 generates compressed data dimensionally reduced, for example, to two dimensions using principal component analysis.

The control unit 51 performs anomaly detection using a clustering method, based on the compressed data of the energy storage cells generated by the second generation unit 513 (step S14). The control unit 51 classifies the compressed data of the energy storage cells into a normal cluster and an anomalous cluster. Based on the classification result, the control unit 51 detects an energy storage cell corresponding to the compressed data belonging to the anomalous cluster as an anomalous energy storage cell.

The control unit 51 generates a screen including a distribution chart showing the distribution of the compressed data of the energy storage cells and the anomaly detection result (step S15). The control unit 51 generates a screen including a distribution chart in which the compressed data of the energy storage cells is mapped onto two-dimensional coordinates, and information indicating the energy storage device detected as anomalous. The generation of the distribution chart may be performed simultaneously with the generation of the compressed data or the clustering processing. The control unit 51 shows the clustering result visually recognizably on the distribution chart, and displays the normal cluster and the anomalous cluster distinguishably.

The control unit 51 outputs the generated screen including the distribution chart and the anomaly detection result to the terminal device 60 (step S16), to cause the screen to be displayed through the display unit 64 of the terminal device 60. The control unit 51 completes the series of processing steps.

### Second Example Embodiment

An information processing device 50 of a second example embodiment performs, as anomaly detection processing, anomaly detection using an energy storage cell (energy storage device) simulator in addition to anomaly detection using a machine learning method described in the first example embodiment. The following mainly describes the above difference.

The energy storage cell simulator refers to a simulator constructed to simulate the behavior of an energy storage cell. The energy storage cell simulator can output measurement data of an energy storage cell based on an internal state quantity of the energy storage cell. Internal state quantities to be provided to the energy storage cell simulator may include, for example, the SOC, the internal temperature, the positive electrode capacity, the negative electrode capacity, a deviation in capacity balance, etc. of an energy storage cell. The deviation in capacity balance means the difference, between the positive electrode and the negative electrode of the energy storage cell, in capacities for charged ions to reversibly enter and leave the electrodes.

The energy storage cell simulator may further include the use history of an energy storage cell in input elements. The use history means information indicating a usage pattern of the energy storage cell (how the energy storage cell has been used). The use history may include, for example, information indicating the change of the power or current (load) of the energy storage cell over a predetermined period, information indicating the change of the ambient temperature over a predetermined period, etc.

In the following, for convenience of description, an energy storage cell to be subjected to anomaly detection processing is referred to as a target cell, and a cell serving as a comparative reference when anomaly detection is performed is referred to as a representative cell. The representative cell is selected from among the energy storage cells in the power generating system 200 by taking, for example, its position in the power generating system 200 and measurement data of the voltage, the current, the temperature, etc. into consideration.

In step S14 of the first example embodiment, the information processing device 50 of the second example embodiment performs anomaly detection using the energy storage cell simulator as well as anomaly detection using a machine learning method.

The following describes an example of an anomaly detection method using the energy storage cell simulator, which is not limiting. The information processing device 50 determines the respective use histories of a representative cell and a target cell, based on measurement data including the voltages, the currents, and the temperatures of the representative cell and the target cell. The information processing device 50 determines, for each of the representative cell and the target cell, an internal state quantity corresponding to the acquired measurement data and use history, using the energy storage cell simulator. The information processing device 50 sets an assumed value of the internal state quantity and searches for the optimum value of the internal state quantity, based on the set assumed value of the internal state quantity and the determined use history, so that measurement data output from the energy storage cell simulator approximates actual measurement data. The information processing device 50 searches for the optimum value of the internal state quantity using a known optimization method such as a genetic algorithm, the Nelder-Mead method, or a gradient method.

The information processing device 50 determines whether or not the difference between the obtained internal state quantity of the representative cell and the obtained internal state quantity of the target cell is less than a preset threshold value, to detect an anomaly in the target cell. The information processing device 50 determines that the target cell is normal if the difference in the internal state quantities is less than the threshold value, and determines that the target cell is anomalous if the difference in the internal state quantities is higher than or equal to the threshold value.

In the above-described example embodiments, the examples in which the information processing device 50 performs each piece of processing in the flowchart have been described. Alternatively, part or all of the above-described processing may be performed by another processing entity such as the domain management device 30, the server device 20, or the terminal device 60.

In the above-described example embodiments, the description has been made using the remote monitoring system as illustrated in FIG. 1. However, the information processing method, the information processing system, and the computer program may be applied to mobile objects (such as automobiles, trains, airplanes, and ships). Further, for example, in addition to remote systems as illustrated in FIG. 1, a form in which all systems are installed (for example, all systems are installed in a mobile object) and contained may be used.

The example embodiments disclosed herein should be construed as illustrative in all respects and not limiting. The technical features described in the examples can be combined with each other. The scope of the present invention is intended to include all modifications within the scope of the claims and equivalents to the claims.

The sequence described in each example embodiment is not limiting. The processing steps may be changed in order and performed as long as no contradictions arise. Two or more of the processing steps may be performed in parallel. The processing entity of each piece of processing is not limiting. The processing in each device may be performed by another device as long as no contradictions arise.

The matters described in the example embodiments can be combined with each other. The independent claims and the dependent claims described in the claims can be combined with each other in all possible combinations regardless of the reference forms. Further, the claims use a form to describe a claim referring to two or more other claims (multi-claim form), which is not limiting. The claims may be described using a form to describe a multi-claim referring to at least one multi-claim (multi-multi claim).

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An information processing method comprising performing, using a computer, processing including:
acquiring time-series measurement data of a plurality of energy storage devices; and
generating compressed data by performing compression processing on difference data between acquired time-series measurement data of each of the plurality of energy storage devices and reference measurement data.

2. The information processing method according to claim 1, further comprising detecting an anomaly in each of the plurality of energy storage devices based on the compressed data.

3. The information processing method according to claim 1, further comprising outputting distribution information visualizing distribution of the compressed data.

4. The information processing method according to claim 1, further comprising:
classifying the compressed data into a normal cluster and an anomalous cluster using a clustering method; and
detecting an anomaly in each of the plurality of energy storage devices based on a result of the classifying.

5. The information processing method according to claim 4, further comprising superimposing the normal cluster and the anomalous cluster on distribution information visualizing distribution of the compressed data and outputting in a visually distinguishable form.

6. The information processing method according to claim 1, further comprising generating the difference data by calculating a difference between a mean value or a median value of the acquired time-series measurement data of the plurality of energy storage devices at a same point in time as the reference measurement data and the acquired time-series measurement data of each of the plurality of energy storage devices.

7. The information processing method according to claim 1, wherein the compression processing is performed using principal component analysis, UMAP, t-SNE, or an autoencoder.

8. The information processing method according to claim 1, wherein the acquired time-series measurement data includes at least one of a voltage, a temperature, or a state of charge of each of the plurality of energy storage devices.

9. The information processing method according to claim 2, further comprising detecting an anomaly in each of the plurality of energy storage devices using an energy storage device simulator that estimates the acquired time-series measurement data of the energy storage device based on an internal state of the energy storage device.

10. An information processing system comprising:
a controller configured or programmed to include:
an acquisition unit configured or programmed to acquire time-series measurement data of a plurality of energy storage devices; and
a generation unit configured or programmed to generate compressed data by performing compression processing on difference data between acquired time-series measurement data of each of the plurality of energy storage devices and reference measurement data.

11. A non-transitory computer-readable medium including a computer program executable to cause a computer to perform processing including:
acquiring time-series measurement data of a plurality of energy storage devices; and
generating compressed data by performing compression processing on difference data between acquired time-series measurement data of each of the plurality of energy storage devices and reference measurement data.
